(19) United States
(12) Patent Application Publication
(10) Pub. No.: US 2008/0160493 A1
(43) Pub. Date: Jul. 3, 2008

(54) Western trail competition layout set and training/practice method related thereto

(76) Inventor: Gloria Jean Syfan, Gainesville, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/646,626

(22) Filed: Dec. 28, 2006

(51) Int. Cl. G09B 25/00

(52) U.S. Cl. 434/392

(57) ABSTRACT

A western trail competition layout set, and the training/practice method thereof, wherein a set of miniature trail competition obstacles and a miniature animal are provided within a suitably sized portable container, thereby enabling the components to be easily transported and assembled at an actual competition location, wherein upon arrival, registration, and receipt of the two-dimensional representation of the competition course layout, a user may set up a model of the competition course, such an arrangement of poles that must be stepped over, small fences that must be jumped over, gates to be open and shut, lines of poles to be backed up therethrough, and even water to walk through, and wherein the user may utilize the miniature animal to walk through and practice/learn/train the actual layout, repeatedly, in advance of the actual event.

### TECHNICAL FIELD

The present invention relates generally to horseback riding competition training devices and methodologies and, more specifically, to a competition layout set and the training/practice method thereof, wherein realistically designed obstacle components enable a competitor to quickly and easily assemble virtually any competition configuration, thereby facilitating simulated training/practice sessions within a miniaturized version of the specific ring layout to be faced during a competition, wherein such sessions effectively set the three-dimensional conformation of a particular course in the competing rider's mind.

### BACKGROUND OF THE INVENTION

Accomplished horseback riders often participate in a variety of shows and competitions. Whether riding English or Western, the challenge of the ring lures many. Some show classes focus on the horse itself. For example, pleasure classes focus on the performance of the horse. Others, known as equitation, are judged based upon the skill of the rider and the effective response of the horse, such as in dressage. Still others are timed classes, including games, such as Western barrel racing and English stadium jumping.

English breed class competitors seek to have their horse adjudged a superior specimen of a particular breed via evaluation of particular characteristics, such as, for example, the walk of a Tennessee Walking Horse. By contrast, English type class competitors, such as hunters, are evaluated according to their skill in performing tasks, such as jumping fences. Similarly, Western shows are sometimes breed-specific, but tend to focus many show classes on the horse's ability to perform, frequently drawing from traditional ranch activities, such as roping.

Western reining competition requires the horse and rider to perform complex maneuvers. Western trail classes also focus on the performance of the horse and rider, but instead of flat maneuvers, they advance through a series of obstacles and hazards. These obstacles and hazards are designed to test the obedience of the horse, as well as skill on the trail.

Competitors at each such trail class event are faced with a challenging course of activities, such as backing up and opening a fence, crossing a small bridge, walking through water, jumping a small fence, stepping over poles, and the like. Each competition course is individually created with a generally unique layout, wherein riders and their horses are judged as they travel the ring on a loose rein, properly advancing through each obstacle along the correct path and at the proper gait, or pace.

Because the competitors are judged on the horse's performance, including steadiness of appropriate pace, responsiveness to the rider, and attitude and manners, in addition to obstacle performance, comfortable knowledge of the course layout is necessary for success. Improper travel between obstacles, hesitancy and/or unsteadiness of movement result in deductions from the competitor's score. However, while the horse and rider can repeatedly practice general skills and task maneuvers, because each trail competition is generally unique, the course itself cannot be studied until arrival at the competition.

Typically, following registration, each rider is provided with a two-dimensional, printed representation of the competition trail course. The course itself, however, is frequently not set in place in the competition ring until just prior to the actual trail event because the ring is typically utilized for other competition events. Thus the trail competitors are unable to observe the three-dimensional conformation of the course until a brief practice session just prior to the competition performance. Because the obstacle placement in the ring does not obviously direct the horse and rider along the correct path, the rider is disadvantageously left with the difficult task of translating the two-dimensional course layout into the three-dimensional competition ring with very limited actual practice.

Therefore, it is readily apparent that there is a need for a competition layout set, wherein realistically designed obstacle components enable a competitor to quickly and easily assemble virtually any competition configuration, thereby facilitating simulated training/practice sessions within a miniaturized version of the specific ring layout to be faced during a competition, wherein such sessions effectively set the three-dimensional conformation of a particular course in the competing rider's mind, thereby avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a western trail competition layout set, and the training/practice method thereof, wherein a transportable set of miniature obstacle components, such as, for exemplary purposes only, adjustable height jumps, openable gates, and bridges, along with a suitably sized miniature animal, enables a competitor to practice/learn/train for a particular competition immediately upon receipt of the two-dimensional paper layout representation, essentially without limitation, by setting up a miniaturized course and “walking” the miniature animal through the obstacles, thereby setting the three-dimensional conformation of the particular course in the competing rider's mind.

According to its major aspects and broadly stated, the present invention is therefore a competition layout set and the training/practice method thereof, wherein although especially suited for utilization in western trail competition, beneficial use and/or adaptation may be realized in any type of competitive arena having similar dynamics, wherein simulated hands-on training/practice sessions may take place within a miniaturized version of the specific competition or performance layout to be faced, and wherein portability and ease of assembly facilitate on-site use at essentially any location.

More specifically, the device of the present invention in its preferred form is a set of miniature, multicolor striped poles of varying lengths, adjustable height jumps, gates consisting of two poles with a length of chain removably hooked therebetween, and a suitably sized miniature animal, preferably a pig or a horse. One skilled in the art would readily recognize that other components could be included, such as bridges, simulated streams, mailboxes and/or any related obstacle or task workpiece that is contemplated for potential inclusion in such competitions. The set is provided within a suitably portable container, thereby enabling the components to be easily transported and assembled at any location.

Accordingly, the preferred training/practice method and system of the western trail competition layout set is commenced on-site, upon receipt of an original layout during competition registration. Preferably, in the first step, the trail course layout three-dimensional configuration is created by the competing participant with the components of the western trail competition layout set. For example, poles of appropriately relative length are selected, according to the printed course layout, and are placed on a flat surface, such as the floor or on a table, in an arrangement, such as, for example, in a triangular or parallel relative placement. Gates, bridges, and other obstacles are positioned, also according to the printed course layout.

Following completion of three-dimensional course model, the rider may visually observe the ring set-up, studying same relative to the printed layout, and considering both the proper trail through the obstacles and the gait or pace that is directed for passage therethrough. Thereafter, the rider may direct the movement of the miniaturized toy animal through the course, simulating the actual directional path to be followed during the competition. Through this three-dimensional, interactive practice technique, the rider is able to recognize and remember the course arrangement and to subsequently compete in a more confident and prepared manner.

Therefore, a feature and advantage of the present invention is the ability of such a device and system to provide a simulated opportunity to repeatedly walk and/or experience the actual layout of a competition prior to practice entry into the ring.

Another feature and advantage of the present invention is the ability of such a device and system to present a three-dimensional representation of virtually any trail course layout.

Another feature and advantage of the present invention is the ability of such a device and system to assist a rider in directing a horse to smoothly advance through competition obstacles in the proper order and gait.

Yet another feature and advantage of the present invention is the ability of such a device and system to enable competitors to practice/learn/train for a particular competition course layout as soon as the paper layout is received, essentially without limitation.

Still another feature and advantage of the present invention is the ability of such a device and system to set the three-dimensional conformation of a particular competition course in a rider's mind.

Yet still another feature and advantage of the present invention is the ability of such a device and system to be quickly and easily transported.

Yet another feature and advantage of the present invention is the ability of such a device and system to produce a generally endless variety of trail, horsemanship, equitation, and western riding course layouts, thereby increasing the adaptive usefulness thereof for essentially any competition.

Still yet another feature and advantage of the present invention is the ability of such a device and system to enable a user to efficiently and effectively practice and train for a specific competitive performance.

Another feature and advantage of the present invention is the ability of such a device and system to provide a means for designing new course layouts.

Another feature and advantage of the present invention is the ability of such a device and system to simulatedly increase the number of practice runs available to a competitive rider prior to a competition.

These and other features and advantages of the present version of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is an exemplary original trail course print layout;

FIG. 2 is a perspective view of a western trail competition layout set according to the preferred embodiment of the present invention, showing a user assembling obstacles for a practice session; and

FIG. 3 is a perspective view of a western trail competition layout set, according to the preferred embodiment of the present invention, showing the set stored in a transportable case.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

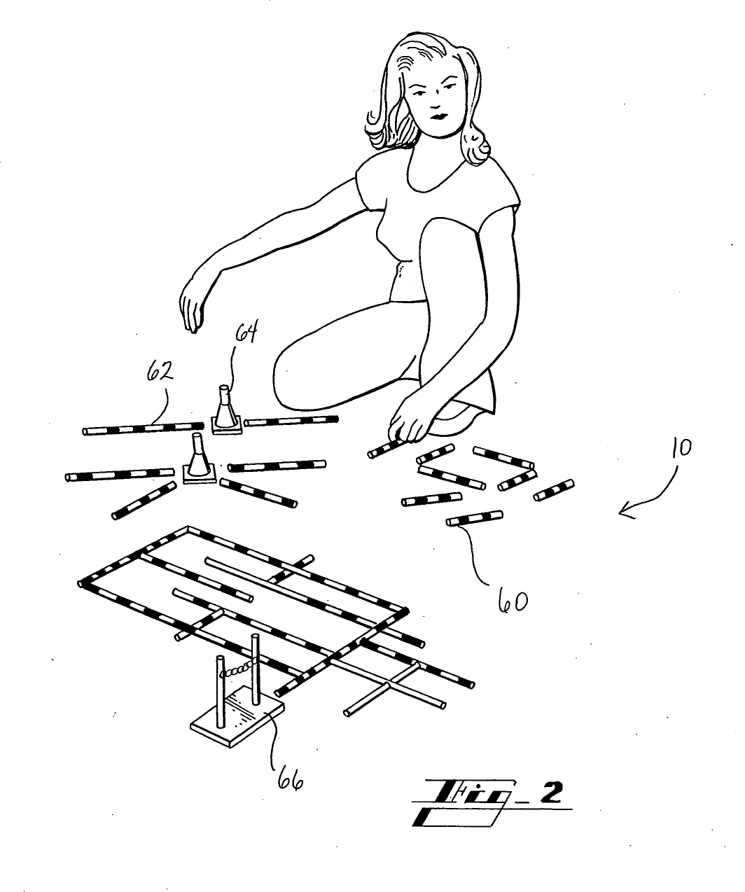

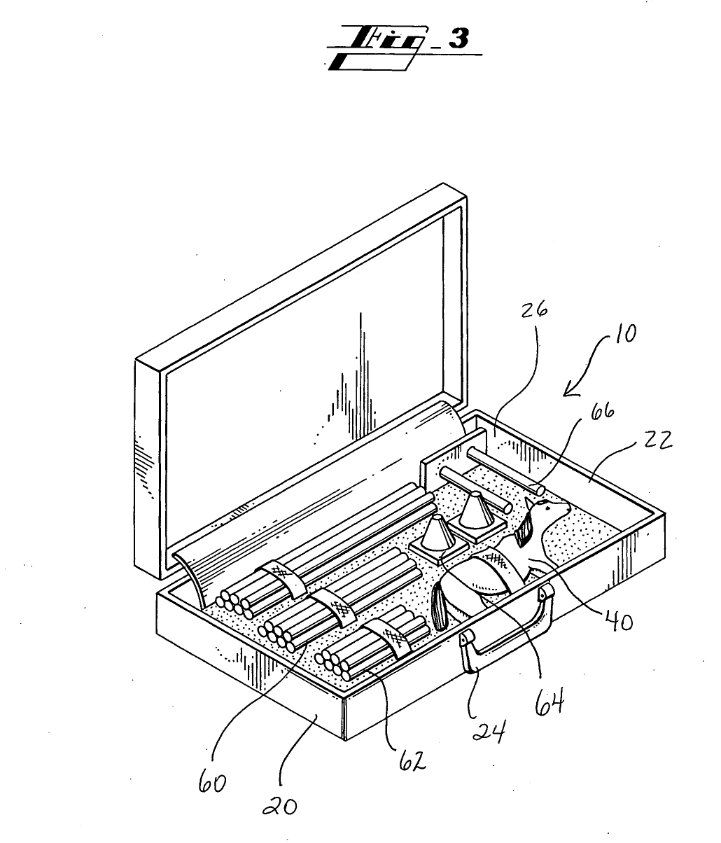

Referring now to FIGS. 2-3, the present invention is western trail competition layout set 10, and the system and method thereof, preferably comprising container 20, animal 40, and plurality of obstacles 60. Preferably, container 20 is case 22 having carry handle 24; however, it is intended that other alternate forms could be used for container 20, such as, for exemplary purposes only, tote-style bags, gym-style bags, roll-style bags, duffel bags, backpacks, tackle-box style containers, shoulder bags, and/or any other suitable container styled for receiving and transporting of components, as described herein. Thus, styling of container 20 could be essentially unlimited, wherein a variety of market targeted designs could be provided, such as the utilization of age-group specific design, coloration, licensed character embroidery and the like, for exterior appeal. Also, container 20 could be decoratively shaped, such as saddle, hat, or boot shaped, wherein interior compartment 26 would receive plurality of obstacles 60 therein. Further, carry handle 24 could be defined as a shoulder strap in order to facilitate ease of hands-free transport.

Preferably, plurality of obstacles 60 comprises plurality of miniature poles 62, jump stands 64, and gates 66. Preferably, plurality of miniature poles 62 are multicolored and/or striped in order to most accurately imitate actual competition obstacle components. Also preferably, a plurality of lengths for plurality of miniature poles 62 is provided in order that a wide variety of obstacles may be created therewith.

Jump stands 64 preferably enable adjustment with respect to the height of the jumps created therewith, whereby multi-pole jumps and/or low or high single-pole jumps may preferably be formed. Gates 66 preferably include chain lengths, string simulating rope, bar latch, and/or any other type of open/close obstacle that may typically be presented in a competition. Animal 40 is preferably suitably sized for realistic interaction with obstacles 60, wherein any miniature animal could be utilized, but preferably a pig or a horse.

Plurality of obstacles 60 preferably comprises a variety of optionally selectable components, such as bridge (not shown), simulated streams (not shown), and mailboxes (not shown). It is specifically contemplated herein that other related obstacle or task workpiece that is contemplated for potential inclusion in such western trail competitions may be included within western trail competition layout set 10.

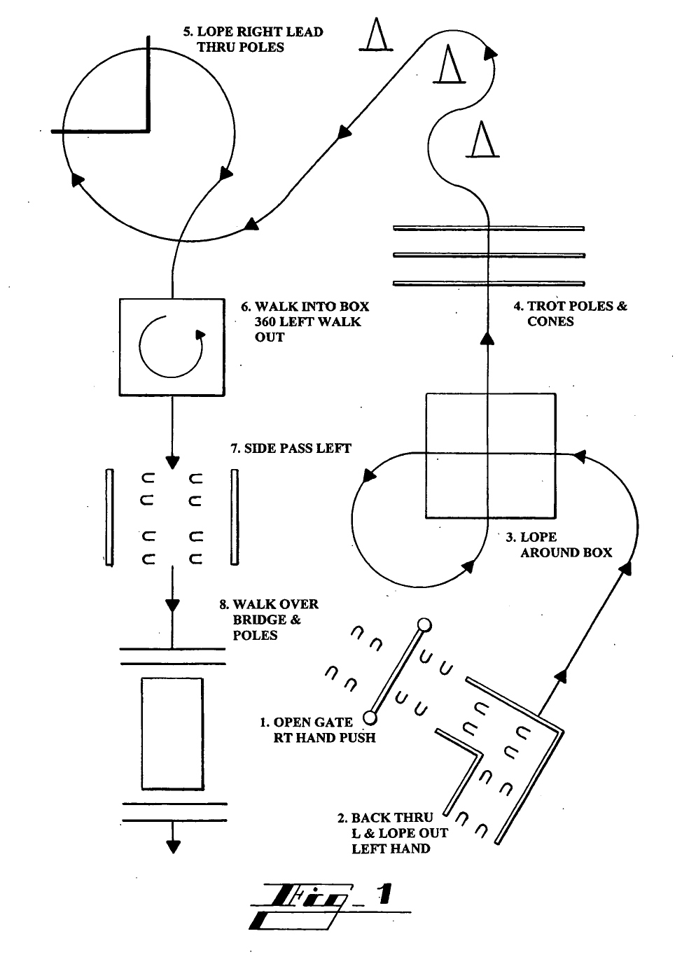

According to the preferred use, western trail competition layout set 10 is transported via container 20, thereby enabling assembly and use at a selected competition location. Typically each competitor receives an original printed layout during competition registration, such as exemplarily provided in FIG. 1. Upon receipt thereof, a user of set 10 selects appropriate pieces from plurality of poles 62, preferably laying same out on a suitable surface, as depicted in FIG. 2. The remaining obstacles of the competition trail course layout are thereafter created, three-dimensionally, via user of western trail competition layout set 10.

Following completion of the three-dimensional course model, the competitor can visually observe the actual competition ring set-up that she will be facing, albeit miniaturized. Thus, even before the actual competition ring is set up, the competitor can study and learn the three-dimensional structure of the western trail competition ring. Referring again to FIG. 1, for example, the competitor can direct animal 40 along the proper trail through the obstacles, memorizing the proper turns, and practicing the appropriate gait or pace, in a simulated fashion. Through this three-dimensional, interactive practice technique, the rider is able to recognize and remember the course arrangement and to subsequently compete in a more confident and prepared manner.

When competition practice is concluded, the user of the western trail competition layout set 10 quickly and easily disassembles the components, preferably replacing each within container 20 for transport.

It is contemplated in an alternate embodiment, container 20 could have a decorative outer surface, formed from shaped and/or otherwise molded, sculpted or formed material, such as plastic, metal, fabric or any other suitable desirable material, wherein the decorative outer surface could incorporate, for exemplary purposes only, any desired fashion coloration or design, holographic pattern and/or image, reflective ornamentation, distinctive coloration, lights, insignia, logo, mascot depiction, seasonal ornamentation, religious indicia, patriotic colors, and/or licensed characters.

In another alternate embodiment, western trail competition layout set 20 could have fencing or a ring, wherein a user could define a perimeter for the model setup.

In yet another alternate embodiment, a grid-marked cloth, board, mat or other such underlayment could be included in order to facilitate scale relative placement of obstacles.

In still another alternate embodiment, stickers, markers, or other indicator members could be included in order to enable a user to selectively indicate gait or pace directives, such that during practice with the model, the preferred competition pace may be reinforced.

In yet still another alternate embodiment, string, yarn or other formable, elongate material could be included in order to enable a user to selectively extend same along the directed path of travel through the obstacles, marking direction for proper advancement therethrough.

In still yet another alternate embodiment, the component functionality of western trail competition layout set could be defined within a computer simulation program, wherein via installation on a handheld or other suitable device, a user could set up a virtual three-dimensional model and wherein a user could practice riding therethrough via a virtual reality experience, with a variety of views.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A portable competition layout set, comprising:
a plurality of poles;
a plurality of pole supports; and
a gate.

2. The portable competition layout set of claim 1, wherein said plurality of poles, said plurality of pole supports, and said gate are realistically configured as simulated, miniaturized horse competition obstacles.

3. The portable competition layout set of claim 1, wherein said competition layout set further comprises at least one adjustable height jump.

4. The portable competition layout set of claim 1, wherein said competition layout set further comprises a bridge.

5. The portable competition layout set of claim 1 wherein said competition layout set further comprises a miniaturized animal.

6. The portable competition layout set of claim 1, wherein said plurality of poles further comprises a plurality of multicolor poles of varying lengths and wherein said gate further comprises two poles with a support and a length of chain removably linked therebetween.

7. The portable competition layout set of claim 1, wherein said competition layout set further comprises a simulated stream.

8. The portable competition layout set of claim 1, wherein said competition layout set further comprises a mailbox.

9. The portable competition layout set of claim 1, further comprising a container, said container dimensioned to retain said plurality of set components therein.

10. The portable competition layout set of claim 9, wherein said container is selected from a group comprising brief case, tote-style bag, gym-style bag, roll-style bag, duffel bag, backpack, tackle-box style container, or shoulder bag.

11. The portable competition layout set of claim 9, wherein said container is decoratively shaped.

12. The portable competition layout set of claim 1, further comprising ring fencing.

13. The portable competition layout set of claim 1, further comprising a scaled underlayment.

14. The portable competition layout set of claim 1, further comprising a plurality of gait indicator members.

15. The portable competition layout set of claim 1, further comprising a formable, elongate path indicating material.

16. The portable competition layout set of claim 1, wherein said components are virtually defined in a computer simulation program.

17. A method of training for a competition, comprising the steps of:
a) obtaining a competition layout set comprising a plurality of selectable obstacle components and an animal;
b) obtaining a course plan for a competition;
c) utilizing said plurality of selectable obstacle components to form a three-dimensional representation of the course plan;
d) training for the course by advancing said animal through said three-dimensional representation.

18. The method of training for a competition of claim 17, wherein said competition layout set is computer-based, wherein said three-dimensional representation is virtual, and wherein said training is virtual.
